(19) United States
(12) Patent Application Publication
(10) Pub. No.: US 2026/0117953 A1
(43) Pub. Date: Apr. 30, 2026

(54) DECORATIVE PANEL

(71) Applicants: KOJIMA INDUSTRIES CORPORATION, Toyota-shi (JP); TOYOTA MOTOR KYUSHU, INC., Miyawaka-shi (JP)

(72) Inventors: Kosuke SUZUKI, Toyota-shi (JP); Naokatsu NOGUCHI, Toyota-shi (JP); Yutaka NAGAMINE, Toyota-shi, Aichi (JP); Yusuke NAKANISHI, Miyawaka-shi (JP)

(21) Appl. No.: 19/366,515

(22) Filed: Oct. 23, 2025

(30) Foreign Application Priority Data
Oct. 25, 2024 (JP) 2024-188072

(51) Int. Cl. F21V 5/00; F21W 121/00

(52) U.S. Cl. CPC F21V 5/00; F21W 2121/00

(57) ABSTRACT

A decorative panel includes: a first member that transmits light; a second member that has a front surface in contact with a back surface of the first member, a refractive index same or substantially the same as a refractive index of the first member, a transmittance lower than a transmittance of the first member, and irregularities formed on the front surface; and a light source disposed to irradiate light from a side of the front surface of the second member.

### CROSS-REFERENCE TO RELATED APPLICATION

The present application claims priority to and incorporates by reference the entire contents of Japanese Patent Application No. 2024-188072 filed in Japan on Oct. 25, 2024.

### BACKGROUND

The present disclosure relates to a decorative panel.

As a decorative laminate intended for decoration, for example, there is a decorative laminate disclosed in JP 2020-157671 A. This decorative laminate has a design changed by light in an ambient environment and light from a light source disposed behind, and includes a first concavo-convex layer disposed on a light source side and having a concavo-convex surface, and a reflective layer disposed on a side opposite to the light source with respect to the first concavo-convex layer and having an OD value from 0.7 to 1.7. In this decorative laminate, in a state that the light source disposed behind is turned off, light entering from an upper surface is reflected by the reflective layer, and a design according to the reflective layer is visually recognized by an observer. In addition, in this decorative laminate, when the light source disposed behind is turned on, light from the light source is transmitted through the first concavo-convex layer and the reflective layer, and a design different from the state that the light source is turned off is visually recognized by the observer due to a light dispersion effect on a prism by the first concavo-convex layer.

### SUMMARY

There is a need for providing a decorative panel that allows different designs to be seen without using a reflective layer.

A decorative panel according to the present disclosure includes: a first member that transmits light; a second member that has a front surface in contact with a back surface of the first member, a refractive index same or substantially the same as a refractive index of the first member, a transmittance lower than a transmittance of the first member, and irregularities formed on the front surface; and a light source disposed to irradiate light from a side of the front surface of the second member.

### BRIEF DESCRIPTION OF THE DRAWINGS

FIG. 1 is a diagram illustrating an example of an appearance of a decorative panel according to an embodiment;

FIG. 2 is a cross-sectional view taken along line A-A in FIG. 1;

FIG. 3 is a diagram schematically illustrating a state of light when a light source is turned on;

FIG. 4 is a diagram illustrating an example of a design visually recognized by a viewer when the light source is turned on;

FIG. 5 is a diagram schematically illustrating a state of light when a transmittance of a second member is increased;

FIG. 6 is a diagram illustrating a modification of an arrangement position of the light source; and

FIG. 7 is a diagram illustrating an example of a cross section of a decorative panel according to a modification.

### DETAILED DESCRIPTION

In a decorative laminate disclosed in JP 2020-157671 A, in order to visually recognize different designs when the light source is turned on and when the light source is turned off, a step of forming a reflective layer that transmits light on a first concavo-convex layer is required, and there is a problem that it takes time and effort to manufacture the decorative laminate.

Hereinafter, an embodiment of the present disclosure will be described in detail with reference to the accompanying drawings. Note that the present disclosure is not limited by the embodiment described below. In addition, in the description of the drawings, the same or corresponding elements are appropriately denoted by the same reference numerals. Furthermore, note that the drawings are schematic, and dimensional relationships and the like of respective elements may be different from actual ones. Portions having different dimensional relationships and ratios may be included in the drawings.

Furthermore, an orthogonal coordinate system of an X axis, a Y axis, and a Z axis is appropriately illustrated in the drawings, and directions will be described according to the orthogonal coordinate system. A direction in which an X component increases in a space indicated by the orthogonal coordinate system is referred to as a +X direction, and a direction in which the X component decreases is referred to as a −X direction. Similarly, Y and Z components are also defined as a +Y direction, a −Y direction, a +Z direction, and a −Z direction.

### Embodiment

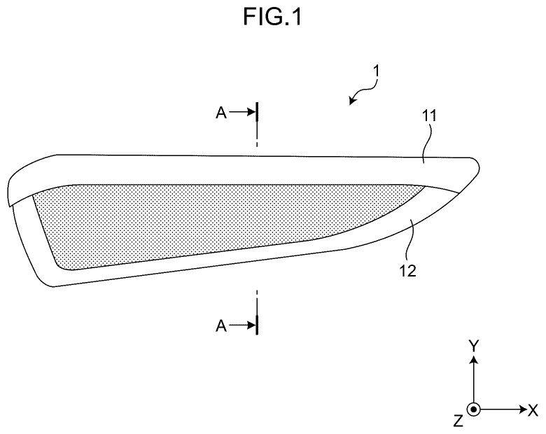

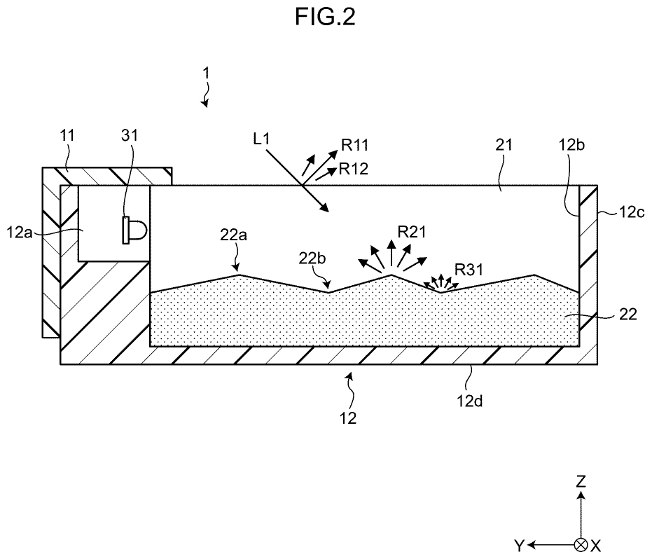

FIG. 1 is a diagram illustrating an example of an appearance of a decorative panel 1 according to an embodiment of the present disclosure. FIG. 2 is a cross-sectional view taken along line A-A in FIG. 1. The decorative panel 1 is a panel used for interior of a vehicle, such as a console, an instrument panel, a door ornament, a ceiling, or a floor of the vehicle, and is disposed in the vehicle such that the +Z direction side faces the inside of the vehicle. The decorative panel 1 includes a cover 11, a base 12, a first member 21, a second member 22, and a light source 31. The decorative panel 1 has a front side on the +Z direction side and a back side on the −Z direction side. In the first member 21 and the second member 22, a surface on the +Z direction side is a front surface, and a surface on the −Z direction side is a back surface.

The base 12 is formed of, for example, a synthetic resin, and is provided with a recess 12a that houses the light source 31 at a predetermined depth in the −Z direction, and a recess 12b that is deeper than the recess 12a and houses the first member 21 and the second member 22. The cover 11 is made of, for example, a synthetic resin. The cover 11 covers an end of the base 12 on the +Y direction side to cover the recess 12a, and is coupled to the base 12.

The second member 22 is black in color and has a lower transmittance than the first member 21. The second member 22 is disposed in the recess 12b. The surface on the +Z direction side of the second member 22 has a convex 22a protruding to the +Z direction side and a concave 22b on the −Z direction side from an apex of the convex 22a. The first member 21 is transparent, has a higher transmittance than the second member 22, and is laminated on the second member 22 such that the surface on the −Z direction side of the first member 21 is in contact with the surface on the +Z direction side of the second member 22.

The first member 21 and the second member 22 are made of, for example, a synthetic resin. Materials of the first member 21 and the second member 22 are, for example, acrylic resin, polyethylene terephthalate, polycarbonate, polyvinyl chloride, or polystyrene. The first member 21 and the second member 22 are preferably made of the same material and have substantially the same refractive index, and more preferably have the same refractive index. When the first member 21 and the second member 22 have substantially the same refractive index, a difference between the refractive index of the first member 21 and the refractive index of the second member 22 is preferably 0.1 or less.

The light source 31 is, for example, a light emitting diode (LED). The light source 31 is turned on and off by, for example, a switch (not illustrated). When the switch is turned on and a current flows, the light source 31 turns on and irradiates a side surface of the first member 21 with light. When the switch (not illustrated) is turned off and no current flows, the light source 31 turns off. The number of the light sources 31 is not limited to one, and a plurality of light sources may be arranged at intervals in the X-axis direction.

When the light source 31 is turned off, as illustrated in FIG. 2, light L1 reaching the first member 21 from the +Z direction side is partially specularly reflected on the front surface of the first member 21 to become specular reflection light R11, and partially diffusely reflected on the front surface of the second member 22 to become diffuse reflection light R12. Furthermore, since the first member 21 and the second member 22 have the same refractive index, the light L1 entering the first member 21, without being reflected by the surface on the +Z direction side of the first member 21, is not specularly reflected by the surface on the +Z direction side of the second member 22, and partially absorbed by the second member 22. The light diffusely reflected by the convex 22a of the second member 22 becomes diffuse reflection light R21, and the light diffusely reflected by the concave 22b of the second member 22 becomes diffuse reflection light R31.

When the light source 31 is turned off, an intensity of the specular reflection light R11 and an intensity of the diffuse reflection light R12 are higher than intensities of the diffuse reflection light R21 and the diffuse reflection light R31. In addition, the intensities of the diffuse reflection light R21 and the diffuse reflection light R31 are low due to absorption of the light L1 by the second member 22. Therefore, a viewer who visually recognizes the decorative panel 1 cannot recognize a shadow caused by a difference between the diffuse reflection light R21 and the diffuse reflection light R31. As a result, the viewer cannot visually recognize a shape of the surface on the +Z direction side of the second member 22. When light strikes an object in the air, specular reflection light (highlight) and diffuse reflection light (color) are generated. Although the viewer recognizes a shape of the object by these two types of reflection light, the refractive indexes of the first member 21 and the second member 22 are the same, and no specular reflection light is generated on the front surface of the second member 22. Thus, a direction of the shape of the surface on the +Z direction side of the second member 22 is more difficult to be recognized.

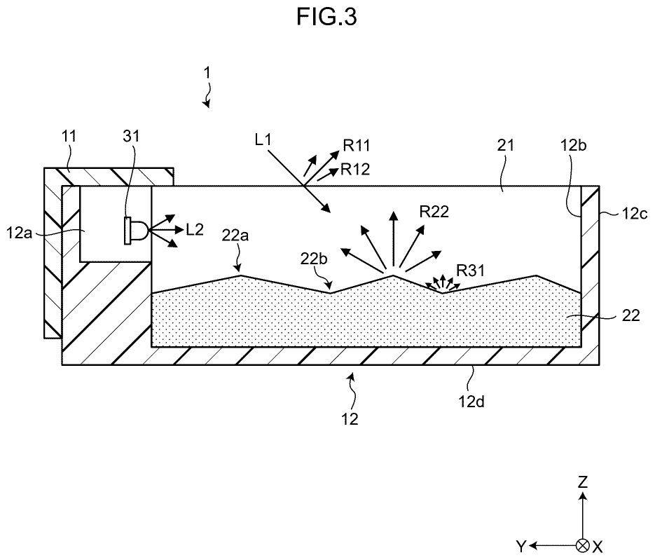

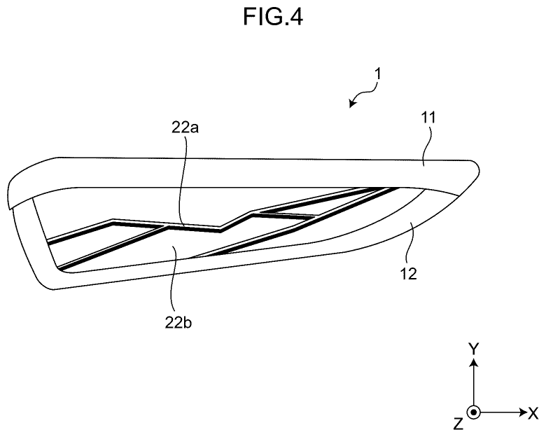

FIG. 3 is a diagram schematically illustrating a state of light when the light source 31 is turned on. FIG. 4 is a diagram illustrating an example of a design visually recognized by the viewer when the light source 31 is turned on. When the light source 31 is turned on, as illustrated in FIG. 3, the light L1 entering the first member 21 and light L2 emitted from the light source 31 onto the side surface of the first member 21 and entering the first member 21 are diffusely reflected by the convex 22a of the second member 22 to become diffuse reflection light R22. Here, the intensity of the light L2 is higher than the intensity of the light L1 entering from the outside, and the intensity of the diffuse reflection light R22 becomes higher than the intensity of the specular reflection light R11 and the intensity of the diffuse reflection light R12. Therefore, the viewer who visually recognizes the decorative panel 1 can recognize the shadow caused by a difference between the diffuse reflection light R22 and the diffuse reflection light R31, and can visually recognize the shape of the surface on the +Z direction side of the second member 22 as illustrated in FIG. 4.

As described above, according to the present embodiment, even when the reflective layer that reflects and transmits light is not provided, it is possible to allow the viewer to visually recognize different designs at the time of turning off and turning on the light source 31. Furthermore, in the decorative laminate disclosed in JP 2020-157671 A, it is necessary to provide a light source on a side opposite to an observation side, and thus the thickness becomes thick. However, in the present embodiment, since the light source 31 is not disposed on the side opposite to the observation side, the thickness of the decorative panel 1 can be reduced.

### Modification

Although the embodiment of the present disclosure has been described above, the present disclosure is not limited to the above-described embodiment, and can be implemented in various other forms. For example, the present disclosure may be implemented by modifying the above-described embodiment as follows. Note that the above-described embodiment and the following modification may be combined. The present disclosure also includes configurations formed by appropriately combining components of the above-described embodiment and modifications. Furthermore, further effects and modifications can be easily derived by those skilled in the art. Therefore, a broader aspect of the present disclosure is not limited to the above embodiment and modifications, and various modifications can be made.

In the above-described embodiment, the color of the second member 22 is black. However, the color of the second member 22 is not limited to black, and may be another color. For example, the color of the second member 22 may be a color having higher brightness than black, such as red, blue, white, or gray.

Therefore, to increase the brightness of the second member 22, it is preferable to increase the transmittance of the second member 22. As for the transmittance of the second member 22, for example, the transmittance of the second member 22 can be changed by adjusting a pigment used for coloring the second member 22.

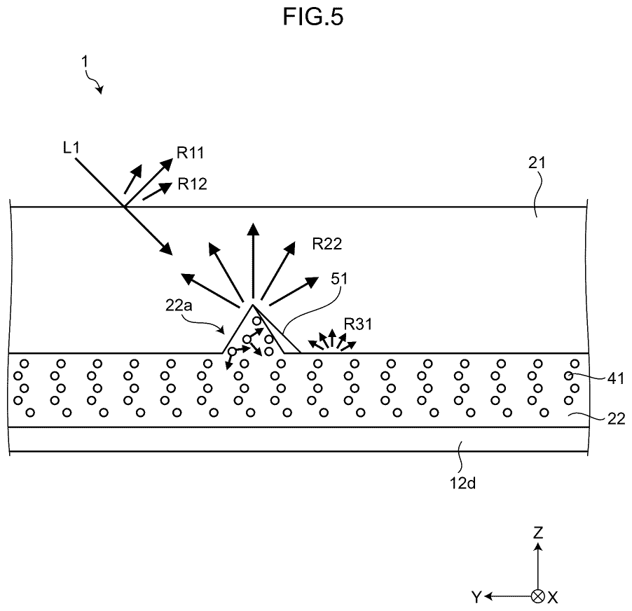

FIG. 5 is a diagram schematically illustrating a state of light when the transmittance of the second member 22 is increased. By reducing a pigment 41 for coloring the second member 22, the transmittance of light in the second member 22 is increased. As compared with a case where an amount of the pigment 41 is large, a quantity of the light L1 transmitted through the second member 22 increases. As the quantity of light transmitted through the second member 22 increases, the intensity of the diffuse reflection light R21 decreases. In addition, since the light diffuses inside the second member 22 as indicated by arrows and a shadow 51 generated near the convex 22a becomes thin, the viewer cannot recognize the shadow caused by the difference between the diffuse reflection light R22 and the diffuse reflection light R31. As a result, the shape of the surface on the +Z direction side of the second member 22 can be hidden even in a state that the light source 31 is turned off. In other words, by adjusting the transmittance of the second member 22 according to the brightness of the second member 22, it is possible to prevent the shape of the surface on the +Z direction side of the second member 22 from being visually recognized when the light source 31 is turned off.

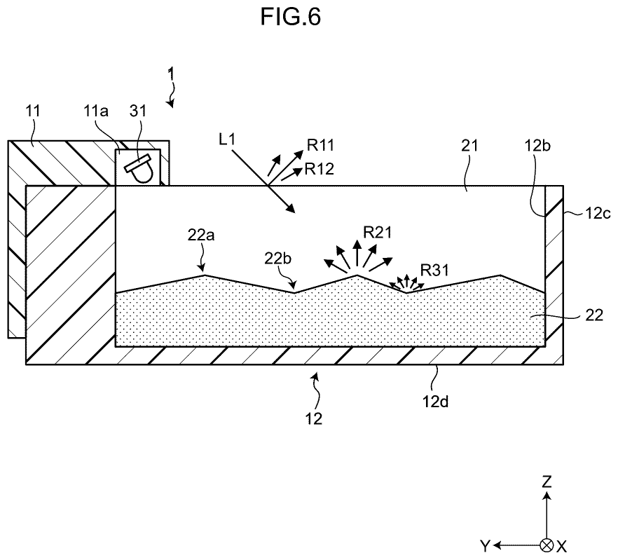

In the above-described embodiment, the light source 31 is arranged on the +Y direction side of the first member 21. However, an arrangement position of the light source 31 is not limited to the position according to the embodiment, and may be another position. FIG. 6 is a diagram illustrating a modification of the arrangement position of the light source 31. As illustrated in FIG. 6, the light source 31 may be disposed on the +Z direction side with respect to the first member 21, and the first member 21 and the second member 22 may be irradiated with light from the +Z direction side. Still more, the light source 31 may be disposed on the −Y direction side, the +X direction side, or the −X direction side with respect to the first member 21.

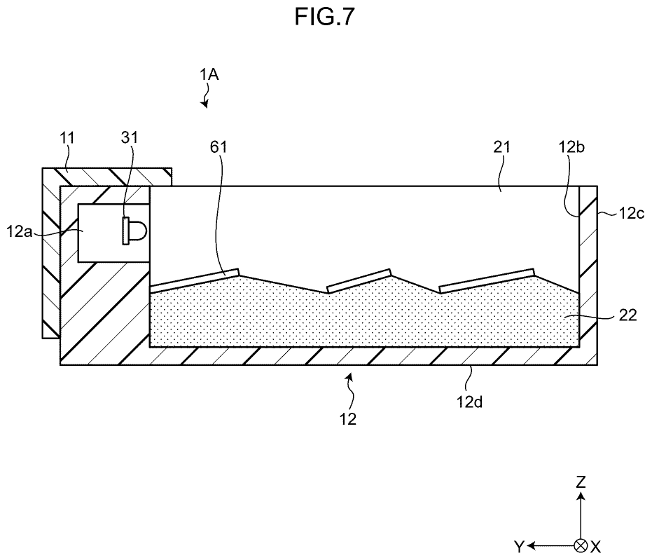

In the above-described embodiment, the decorative panel 1 has the configuration in which the first member 21 and the second member 22 are laminated. However, a resin component to be laminated is not limited to two layers, and may be three layers. FIG. 7 is a diagram illustrating an example of a cross section of a decorative panel 1A according to a modification in which the resin component has three layers. As illustrated in FIG. 7, a third member 61 having a color different from the color of the second member 22 may be disposed between a surface of the second member 22 to which light from the light source 31 is applied and the first member 21. A material of the third member 61 is, for example, the same material as the material of the second member 22. According to this modification, since the surface irradiated with light from the light source 31 and the surface not irradiated with light have different colors on the −Z direction side of the first member 21, the shape of the surface on the +Z direction side of the second member 22 is easily visually recognized when the light source 31 is turned on.

According to the present disclosure, different designs can be visually recognized without using the reflective layer.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A decorative panel comprising:
a first member that transmits light;
a second member that has a front surface in contact with a back surface of the first member, a refractive index same or substantially the same as a refractive index of the first member, a transmittance lower than a transmittance of the first member, and irregularities formed on the front surface; and
a light source disposed to irradiate light from a side of the front surface of the second member.

2. The decorative panel according to claim 1, wherein
the second member is black.

3. The decorative panel according to claim 1, wherein
an appearance changes between when the light source is turned on and when the light source is turned off.
